(19) United States
(12) Patent Application Publication
(10) Pub. No.: US 2009/0303504 A1
(43) Pub. Date: Dec. 10, 2009

(54) IMAGE FORMING APPARATUS, IMAGE FORMING METHOD, AND RECORDING MEDIUM THEREFOR

(75) Inventors: Osamu Iinuma, Machida-shi (JP); Hiroshi Kaburagi, Yokohama-shi (JP); Tsutomu Sakaue, Yokohama-shi (JP); Manabu Takebayashi, Isehara-shi (JP); Reiji Misawa, Tokyo (JP); Naoki Ito, Tokyo (JP); Yoichi Kashibuchi, Tokyo (JP); Junya Arakawa, Kawasaki-shi (JP); Shinji Sano, Kawasaki-shi (JP); Takeshi Namikata, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/363,603

(22) Filed: Jan. 30, 2009

(30) Foreign Application Priority Data
Jan. 31, 2008 (JP) 2008-021422

(51) Int. Cl. H04N 1/60

(52) U.S. Cl. 358/1.9

(57) ABSTRACT

The objective of the preset invention is to easily determine an optimal method for the use of transparent toner. In order to resolve this problem, an image forming apparatus according to the present invention includes an addition unit for adding, to each of objects that constitute an original document, information indicating either that transparent toner is to be printed for the entire surface of the original document or that transparent toner is to be printed for only part of the original document, a storage unit for storing the object and a generating unit for generating image data by employing the object stored in the storage unit, wherein, based on the information added to the object that is stored in the storage unit, the generating unit controls a number of pixels used for printing the transparent toner.

### BACKGROUND OF THE INVENTION

1. Field of the Invention

The present invention relates to an image forming apparatus and an image forming method whereby digital control is exercised to generate image data, employed for forming images on a print sheet, and a recording medium therefor.

2. Description of the Related Art

Since the internal image processing is digitized, the speed at which multi-functional copiers have been developed is remarkable. For these copiers, even their basic functions are too many to enumerate, but include: a COPY function, a PDL function, a SEND (transmission) function, a BOX function and an EDIT function. The COPY function is employed to produce a duplicate of the original document, and the PDL function enables the printing of a document created by a host computer. The SEND function is employed for the transmission of the original document, via an external network, to a copier. The BOX function is employed either for internally storing a document image, generated by the COPY function or the PDL function, or for reusing the document image. The EDIT function is provided to facilitate the performance of synthesis or of bookbinding by employing the image of the original that is stored in the copier by the BOX function.

Further, to satisfy an ongoing demand for better image reproductions, improved copiers are being produced that output higher quality reproductions of originals. However, the image processing resolutions employed have been gradually increased from 600 dpi to 1200 dpi to 2400 dpi, and the number of bits in signals to be processed by copiers has likewise been consecutively increased from 8 bits to 10 bits to 12 bits. Consequently, copiers now require greater memory and storage device capacities for the processing and storage of the expanded volume of bitmap data employed for internal processing, and furthermore, since under these circumstances conventional CPUs will no longer suffice, higher-performance CPUs are being employed. This has resulted in an overall increase in development costs that can not be ignored.

To resolve this problem, a conventional technique provides for separating an original into segments and storing the segments in such a manner that they can easily be used again, and for employing the segments using an editing function. According to this technique, the segments consisting of the original are sorted into data objects, such as those for characters, graphics and images. The character and graphic objects are also vectorized to obtain vector data, which is then stored, while the image object is converted into JPEG data, which is stored so available when the editing function is used (see, for example, Japanese Patent Laid-Open No. 2005-159517). Since a very large amount of bitmap data having multiple bits and high resolutions is not required and vector data that can easily be edited or modified is employed, a cost reduction and an operational improvement can be anticipated. Thus, both image quality and usability can be improved.

As for printing a document recreated using the above described editing function, not only a conventional, full-color electrophotographic printing system employing four toner colors, C, M, Y and K, has drawn attention, but also a multi-color printing system that employs even more special toner colors. Since such printing systems have been developed, on-demand or real-time special printing is within the range for exploitation on the market.

A special toner example is a transparent toner that transforms the surface of printed matter, removing roughness and providing a high gloss, or a light toner that can prevent surface roughness in a highlighted portion.

When a special toner is employed, an added value, which differs from that used for normal digital printing, is newly obtained, and the world of digital printing expanded even further.

For example, by employing a conventional technique whereby, during the process for employing a special toner after a re-editing process has been completed, a transparent toner is applied to coat a portion of a surface to be used for a photograph, but not a portion to be used for characters, so as to secure the maximum visual effect possible (see, for example, Japanese Patent Laid-Open No. 2007-055077). Further, a method according to which meta-data is provided for an object when a transparent toner has been applied to only part of the surface of the object is also commonly used.

However, according to the method whereby meta-data indicating that transparent toner has been employed is simply provided for an object, the optimal method available for applying transparent toner is not identified at the re-editing time. For example, a user can employ a user interface to view objects to be selected, but cannot obtain information specifying how those objects were printed on the original document using transparent toner. Specifically, the user cannot determine whether all of the objects to be selected were printed across the entire surface using transparent toner, or whether only part of the objects were printed using the transparent toner. Therefore, the user does not have sufficient information to determine which method is the optimal one that should be employed after objects have been re-edited.

### SUMMARY OF THE INVENTION

According to an aspect of the present invention, an image forming apparatus comprises an addition unit for adding, to each of objects that constitute an original document, information indicating either that transparent toner is to be printed for the entire surface of the original document or that transparent toner is to be printed for only part of the original document, a storage unit for storing the object; and a generating unit for employing the object, stored in the storage unit, to generate image data that includes the object, wherein, based on the information added to the object that is stored in the storage unit, the generating unit controls a number of pixels used for printing the transparent toner

According to another aspect of the present invention, when an object for which transparent toner has been employed is to be re-edited, the optimal method for applying transparent toner can be easily determined.

Further features of the present invention will become apparent from the following description of exemplary embodiments (with reference to the attached drawings).

### BRIEF DESCRIPTION OF THE DRAWINGS

FIG. 1 is a block diagram illustrating an image forming apparatus according to a first embodiment of the present invention;

FIG. 2 is a diagram related to an MFP (Multi-Functional Printer);

FIG. 3 is a diagram related to the system of the MFP;

FIG. 4 is a flowchart showing the object division processing;

FIG. 5 is a diagram illustrating an example local PC screen, or an example screen on a display device of the MFP;

FIG. 6 is a diagram illustrating a local PC screen, or an example screen on the display device of the MFP;

FIG. 7 is a diagram illustrating example printed matter;

FIG. 8 is a diagram illustrating an example local PC screen, or an example screen on the display device of the MFP;

FIG. 9 is a diagram illustrating an example local PC screen, or an example screen on the display device of the MFP;

FIG. 10 is a diagram showing a relationship between an object and meta-data;

FIG. 11 is a diagram showing a meta-data relationship;

FIG. 12 is a diagram showing a relationship between an image and positioning information;

FIG. 13 is a flowchart showing the processing performed for this embodiment, related to the generation of positioning information;

FIG. 14 is a flowchart showing the image processing internally performed by a data processing unit 211;

FIG. 15 is a flowchart showing the processing performed for a second embodiment of the present invention when a plurality of objects is selected;

FIG. 16 is a diagram showing an example local PC screen, or an example screen on the display device of an MFP;

FIG. 17 is a diagram showing an example local PC screen, or an example screen on the display device of the MFP;

FIG. 18 is a diagram showing an example local PC screen, or an example screen on the display device of the MFP;

FIG. 19 is a diagram showing an example local PC screen, or an example screen on the display device of the MFP;

FIG. 20 is a diagram illustrating a relationship between an image and positioning information;

FIG. 21 is a flowchart showing the processing, performed for a third embodiment of the present invention, related to a method for employing overlapping characters to change a transparent toner printing method;

FIG. 22 is a diagram showing an example local PC screen, or an example screen on the display device of an MFP;

FIG. 23 is a diagram showing an example local PC screen, or an example screen on the display device of the MFP;

FIG. 24 is a diagram showing a relationship between an image and positioning information; and

FIG. 25 is a diagram illustrating all the printing results obtained in accordance with the priority items.

### DESCRIPTION OF THE EMBODIMENTS

Various embodiments of the present invention will now be described with reference to the accompanying drawings.

In accordance with a first embodiment of the present invention, an explanation will now be given for a re-layout method and a printing method employed when a new document is generated using an object for which a transparent toner was employed.

A “user interface” in the description represents both the monitor device of a local PC 102 and a display device 303 of a multifunction printer (hereinafter referred to as an MFP) 101.

### [Image Forming Apparatus]

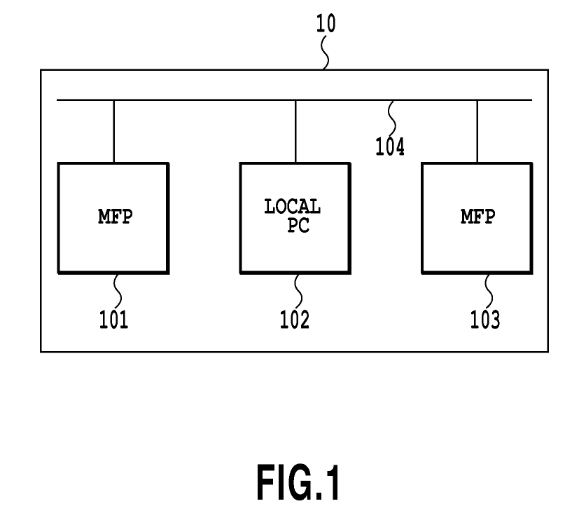

FIG. 1 is a block diagram illustrating the arrangement of an image forming apparatus according to this embodiment.

MFPs (Multi-Functional Printers) 101 and 103, which serve as recording apparatuses, and a local PC 102 are connected to a LAN 104 that is built in an office 10. Here, the MFPs 101 and 103 will normally scan original documents and perform required data processing for image data obtained in this manner, and then use the data processing results to print document copies. But instead of each MFP individually performing all these functions, the MFP 101 may read an original document and perform the required image data processing and then the MFP 103 may do the actual printing. Furthermore, both the MFP 101 and the MFP 103 can interpret Page Description Language (hereinafter referred to as PDL) image code contained in a transmission received from the local PC 102, and print the images described by the code.

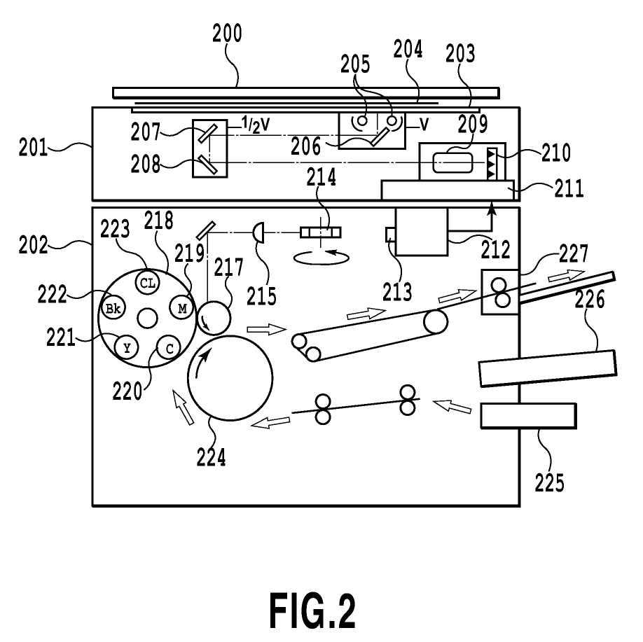

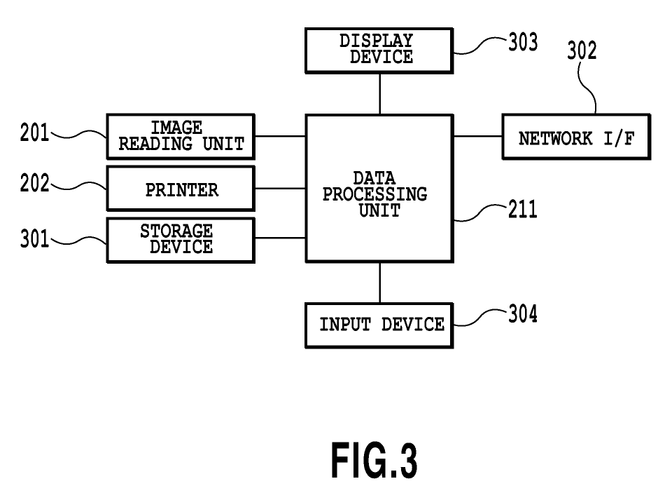

FIGS. 2 and 3 are diagrams representing an MFP. In FIG. 2, an image scanner (an image reading unit) 201 reads an original document and performs the digital signal processing required for the document data. Thereafter, consonant with the document data obtained by the image scanner 201, a printer 202 reproduces a full-color image on a sheet.

The image scanner 201 includes a specular pressure plate 200 and an original glass plate (hereinafter referred to as a platen) 203, on which an original 204 can be mounted and irradiated with light emitted by a lamp 205. The emitted light is reflected and guided to mirrors 206, 207 and 208, and then passes through a lens 209 and forms an image on a three-line, solid-state image pick-up sensor (hereinafter referred to as a CCD) 210. As a result, three image signals representing red (R), green (G) and blue (B) are transmitted as full-color data to a data processing unit 211. The lamp 205 and the mirror 206 are mechanically displaced at a velocity v and the mirrors 207 and 208 are mechanically displaced at a velocity 1/2 v in a direction perpendicular to the electrical scanning (the main scanning) direction of the line sensor, so as to scan the entire face of the original (a sub-scanning procedure). For this process, a resolution of 600 dpi (dots/inch) is employed both for the main scanning and the sub-scanning of the original 204. The image signals for each page of the original are stored in the data storage unit of the data processing unit 211.

The data processing unit 211 electrically processes each pixel of an internally stored image signal, analyzes the signal to separate the magenta (M), cyan (C), yellow (Y) and black (Bk) elements, and transmits these elements to the printer 202. Furthermore, the data processing unit 211 internally generates clear image data (CL) using the pixel units, and also transmits the clear image data to the printer 202.

At the printer 202, the M, C, Bk and CL image signals are received by a laser driver 212. And in consonance with the image signals that are received, the laser driver 212 modulates the focus of a semiconductor laser 213. And a laser beam is projected, via a polygon mirror 214, a f-θ lens 215 and a mirror 216, onto a photosensitive drum 217. At this time, as well as during the scanning process, image data are written, at a resolution of 600 dpi (dots/inch), in both the main scanning and the sub-scanning directions.

A rotary developing device 218 includes a magenta developer 219, a cyan developer 220, a yellow developer 221, a black developer 222 and a clear (transparent) developer 223. When the five developers 219 to 223 alternately contact the photosensitive drum 217, an electrostatic latent image, formed on the photosensitive drum 217, is developed using toners of individual colors.

A transfer drum 224, to which a sheet fed by a sheet cassette 225 or 226 is to be attached, is employed, so that images developed on the photosensitive drum 217 can be transferred to the sheet.

When the five colors, M, C, Y, Bk and clear (transparent), for the images have been sequentially transferred, the sheet is passed through a fixing unit 227, whereby the toner is fixed to the sheet. Thereafter, the sheet is discharged to the exterior.

In FIG. 3, the MFP 101 includes a network I/F 302, used to effect a connection to the LAN 104, and a recording unit 307 that is provided for recording the PDL language transmission that is output, via a driver, by the local PC 102 or another general-purpose PC (not shown). PDL data output, via a driver, by the local PC 102 is received, via the LAN 104 and the network I/F 302, by the data processing unit 211, which then interprets and processes the PDL language code, to convert the PDL data into a signal having a form that can be recorded. Thereafter, the signal is recorded, by the MFP 101, as an image on a recording medium.

A storage device (hereinafter referred to as a BOX) 301 has as a function the storage of data, obtained by performing a rendering process for either data obtained by the image scanner 201 or for PDL data that has been transmitted, via the driver, by the local PC 102.

The MFP 101 is operated by employing a key console unit (an input device 304) with which the MFP 101 is equipped. In response to an order entered at the key console unit, the data processing unit 211 permits the internal controller (not shown) to comply with the order and exercise predetermined control.

The MFP 101 is equipped with a display device 303, on which the operating input state and image data that are to be processed can be displayed.

The MFP 103 also includes a display device 303, which can be used to display the operating input state and image data that are to be processed.

### [Image Processing, Including Transparent Data Generation]

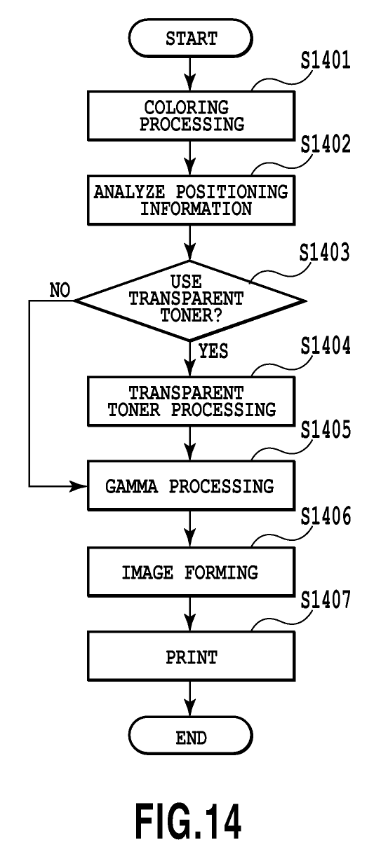

FIG. 14 is a flowchart showing the image processing internally performed by the data processing unit 211. The operations in the flowchart shown in FIG. 14 are performed by a CPU (not shown) provided for an image forming apparatus equipped with an image forming apparatus, according to this embodiment.

In the coloring processing at step S1401, R, G and B signals transmitted by the local PC 102, or the MFP 101 or 103, are converted into C, M, Y and K signals. A matrix operation is employed for THE conversion of C, M, Y and K signals. At step S1402, positioning information is analyzed, and at step S1403, a check is performed to determine whether transparent toner is to be employed for a pixel that is to be processed.

When it is determined at step S1403 that transparent toner is to be employed, at step S1404, the amount of transparent toner is calculated based on the C, M, Y and K signals.

A method employed at step S1404 to calculate the amount of transparent toner will now be described. First, the total amount of the C, M, Y and K toners is calculated for each pixel. The total toner amount indicates the amount of toner that is to be transferred to the sheet for each pixel, in accordance with the total signal value for all the four colors C, M, Y and K. Generally, the total toner amount is expressed using a percentage while the maximum value of a single color is 100%. In a case wherein an image signal is expressed using an integer of eight bits, since the maximum value of a single color is 255, the value obtained by adding the C, M, Y and K signals is multiplied by 100/255, and the thus obtained value is regarded as the total toner amount.

For example, when an image signal of 8 bits for a specific pixel is C=80, M=95, Y=140 and K=110, the total toner amount=

(C+M+Y+K)×100/255=167% (1)

Generally, the normal upper limit value of the total toner amount is about 200 to 280% and is determined by employing an imaging process. In this embodiment, after a transparent toner layer has been formed, the total amount of toner is equal to or lower than the upper limit.

Assuming that the upper limit value of the total amount of toner is 240%, this can be regarded as indicating that a difference between a value represented in expression (1) and the upper limit value is an allowable density ratio for the transparent toner layer. That is,

the allowable amount=240−167=73% (2)

When the amounts of C, M, Y, K and CL (transparent toner) are determined at step S1405, for this printer, an optimal gamma process is performed for the individual colors.

At step S1406, the image forming processing is performed for the individual colors. The image forming processing includes a screen process and an error diffusion process.

Finally, at step S1407, an image is printed.

When a transparent toner is not to be employed at step S1403, the process at step S1404 is skipped and the process beginning at step S1405 is performed.

### [Printing Method Using Transparent Toner]

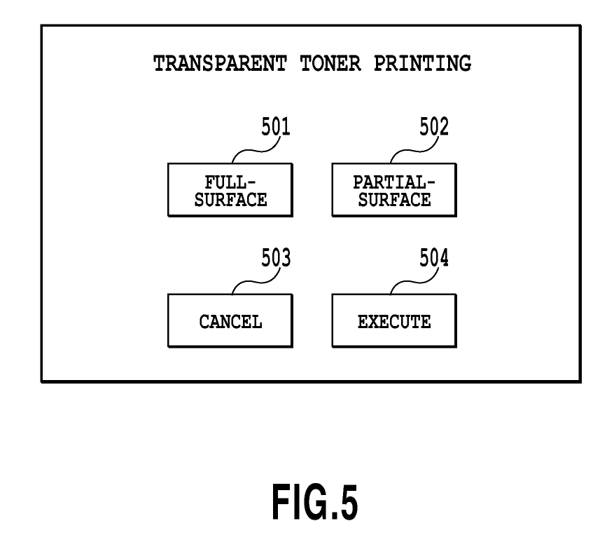

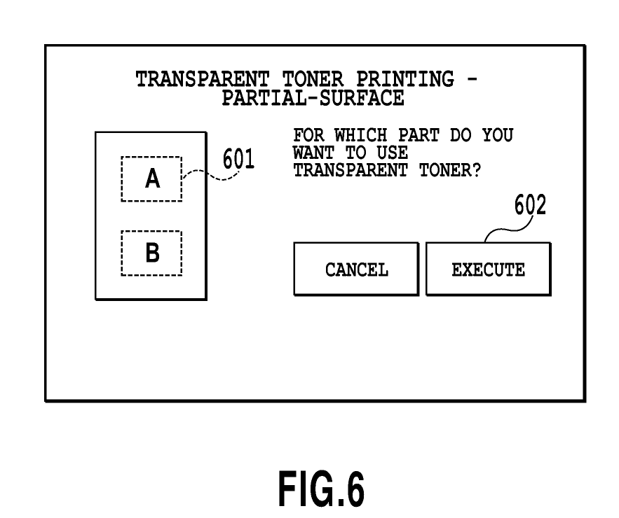

FIGS. 5 and 6 are diagrams illustrating example screens displayed on a user interface.

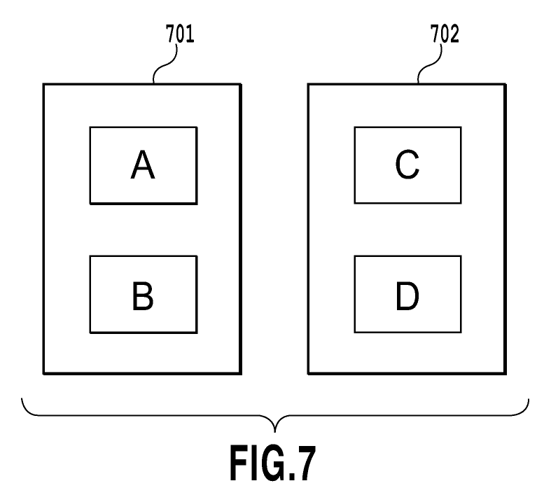

FIG. 7 is a diagram illustrating printed samples.

On the screen in FIG. 5, a transparent toner use method is determined for image data transmitted by the local PC 102 or the MFP 101 or 103. When a user selects a “partial-surface” button 502, a printing method is designated for the partial use of transparent toner for image data 701 in FIG. 7, and the screen in FIG. 6 is displayed on the user interface.

On the screen in FIG. 6, a preview is displayed in an area 601. Using this preview, a portion wherein a transparent toner is to be employed is selected. Assume that both an object A and an object B (areas indicated by dotted lines) are selected. The designation of a printing method for the use of transparent toner is determined by a user designating the portions and selecting an “execute” button 602. Thereafter, when the user selects an “execute” button 504 and enters a printing command, printing is initiated.

When a “full-surface” button 501 is selected by the user, a printing method is thereby designated for the employment of transparent toner for all the image data 702 in FIG. 7. Following this decision, printing is initiated when the user selects the execute button 504 to enter a printing command.

In FIG. 5, a button 503 is provided for the cancellation of a previously selected method for the employment of transparent toner.

### [Transparent Toner Positioning Information]

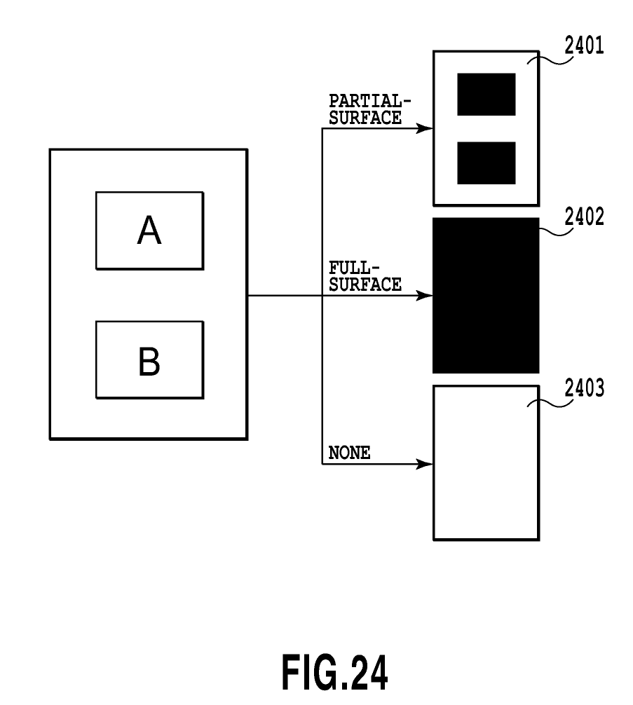

FIG. 24 is a diagram related to transparent toner positioning information.

The transparent toner positioning information (hereinafter referred to simply as positioning information) is accompanied by image data, and indicates an area within which transparent toner printing is to be performed. This information is employed when the transparent toner printing process is performed.

When the button 501 on the screen in FIG. 5 is selected to designate full-surface printing, and the button 504 is depressed, positioning information 2402, as depicted in FIG. 24, is generated for the use of transparent toner printing. Then, when the positioning information 2402 is employed for printing a surface, since the relevant solid black portion shown in FIG. 24 wholly covers a targeted printing area, transparent toner printing is performed across the entire surface.

When the upper button 502 on the screen in FIG. 5 is selected to designate partial-surface printing and transparent toner printing positioning is set using the screen in FIG. 6, a positioning signal 2401 is generated that corresponds to the setting.

When no setting is selected on the screen in FIG. 5, positioning information 2403 in FIG. 24, which does not include any signals, is generated, and transparent toner printing is not performed.

[Storage after Object Division has been Completed]

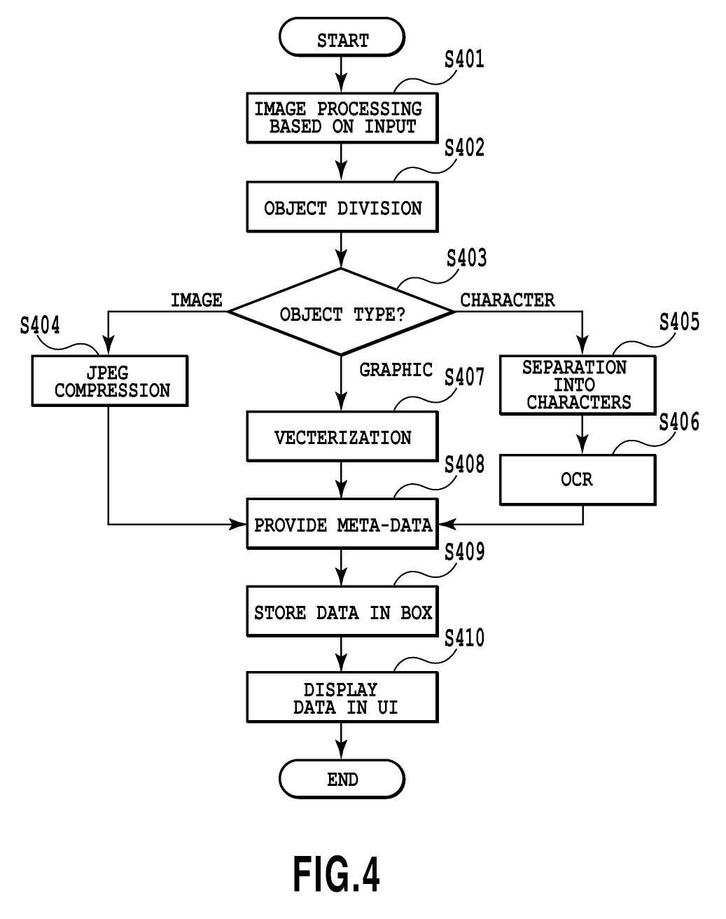

FIG. 4 is a flowchart showing the processing, related to the storage of data, performed following the completion of object division. The processing included in the flowchart in FIG. 4 is to be performed by a CPU (not shown) mounted on the image forming apparatus according to this embodiment.

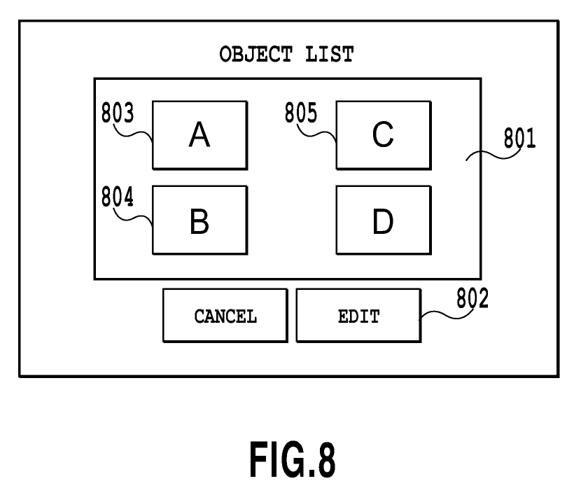

FIG. 8 is a diagram showing an example screen displayed on a user interface.

In this embodiment, it is assumed that data is stored in the BOX 301 at the same time as printing is performed.

At step S401, an optimal image processing is performed in accordance with an instruction entered at the local PC 102 or the MFP 101 or 103. The image process is, for example, either a coloring process or a filtering process. At step S402, image data obtained by the image process is divided into objects. The object types referred to here are a character object, a graphic object and an image object.

At step S403, an object type, or types, into which data is to be divided is determined. When it is determined at step S403 that the object type is an image object, JPEG compression is performed at step S404. When it is determined at step S403 that the object type is a graphic object, the vectorization process is performed at step S407. And when it is determined at step S403 that the object type is a character object, data in a character area is separated to obtain individual characters at step S405, and an OCR (Optical Character Recognition) process is performed at step S406. Further, when it is determined at step S405 that a character object has already been separated, at step S407 the vectorization process is performed for the character object. At step S408, meta-data is provided for the object, and at step S409, the resultant object is stored in the BOX 301. Finally, at step S410, the screen in FIG. 8 is displayed on the UI (User Interface), and the individual objects are displayed in an area 801.

### [Provision of Meta-Data]

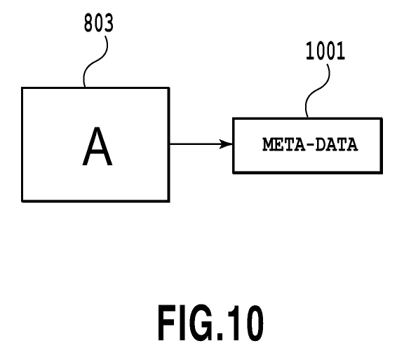

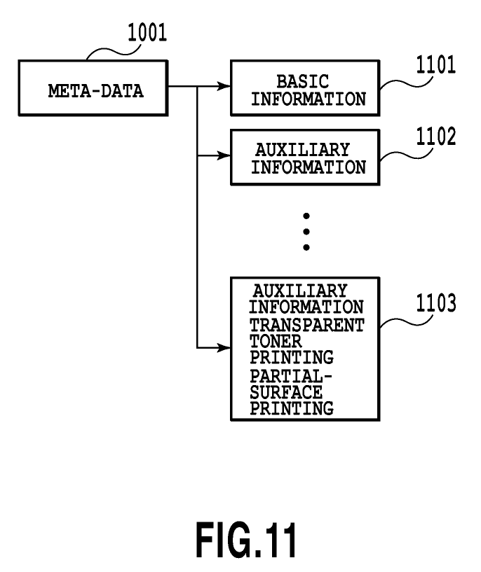

As illustrated in FIG. 10, meta-data 1001 is additionally provided for an object A803. The meta-data 1001 includes basic information 1101 and auxiliary information 1102 and 1103, as shown in FIG. 11. The basic information 1101 indicates, for example, a date and time, a person and a location for the data that was printed, and the auxiliary information 1102 indicates, for example, the size of an object and a resolution. The auxiliary information 1103 is, for example, information related to printing, i.e., in this embodiment, information is supplied indicating whether transparent toner printing has been designated and whether the transparent toner printing, if designated, was employed for the entire surface or only partially. The auxiliary information 1103 may be information related to whether security information, such as pattern code, LVBC (Low Visibility Barcode) or QR code, was employed for the entire surface or only partially.

Assume that information indicating that the local printing of transparent toner was performed is included in the auxiliary information 1103 for the object A803 in FIG. 8. Furthermore, assume that information indicating the partial-surface printing of transparent toner was performed is also included in the auxiliary information 1103 for an object B804 in FIG. 8. Further, assume that information indicating the full-surface printing of transparent toner was performed is included in the auxiliary information 1103 for an object C805 in FIG. 8.

In this embodiment, when the transparent toner is to be employed for the full-surface printing process, “full-surface” is designated in the auxiliary information 1103 of the meta-data 1001 for an object. When the transparent toner is employed for the printing process, “partial-surface” is designated in the auxiliary information 1103 of the meta-data 1001 for the object. And when transparent toner is not used for the printing, “none” is designated in the auxiliary information 1103 of the meta-data 1001 for the object.

### [Re-Use of an Object]

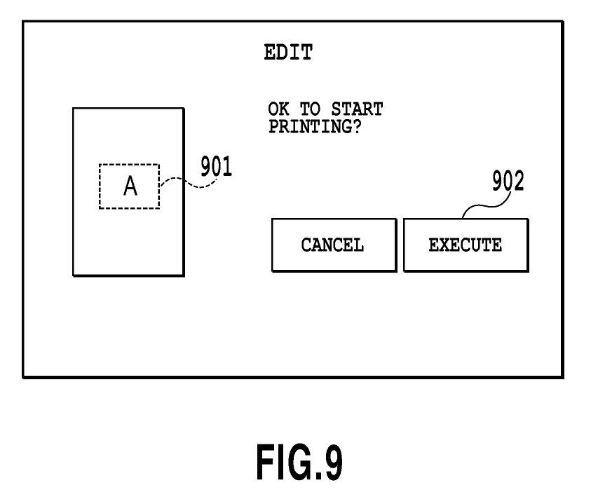

FIG. 9 is a diagram illustrating an example screen displayed on the user interface.

When the object A803 is selected in the area 801 in FIG. 8 and a button 802 is depressed, the screen in FIG. 9 is displayed on the user interface. In FIG. 9, the preview results for the automatic layout are displayed in an area 901, and a portion in which transparent toner is to be employed is displayed using dotted lines. When a button 902 is depressed, the object is printed in accordance with the preview results.

[Printing Using Transparent Toner when an Object is Re-Used]

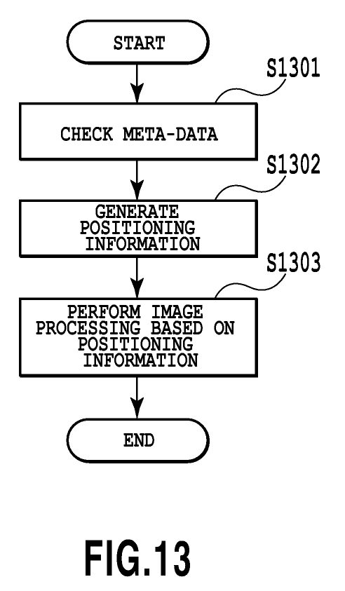

FIG. 13 is a flowchart showing the printing processing performed using transparent toner when an object is re-used. The processing in the flowchart in FIG. 13 is performed by the CPU (not shown) mounted on the image forming apparatus of this embodiment.

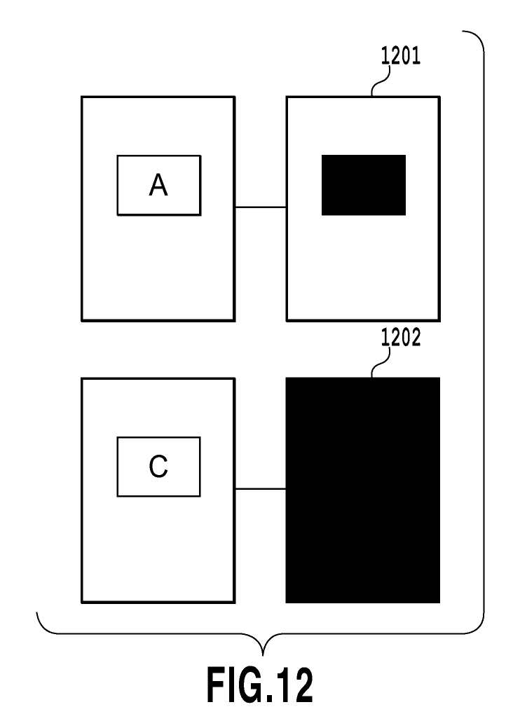

FIG. 12 is a diagram illustrating the state wherein positioning information is prepared when an object is re-used.

When the button 902 in FIG. 9 is depressed, at step S1301, in FIG. 13, the positioning information 1103 in the meta-data 1001 for an object that is re-used is examined to determine how the transparent toner was employed, during the printing, while the storage of data in the BOX 301 was being performed, and at step S1302 positioning information is generated based on the obtained results. As denoted by 1201 in FIG. 12, since transparent toner was partially employed for the object A803 when it was printed, positioning information is generated for only part of the object A803 when it is re-used. On the other hand, as denoted by 1202 in FIG. 12, since transparent toner was employed for the entire surface of the object C805 during printing, positioning information is generated for the entire object C805 when it is re-used.

At step S1303, the positioning information thus generated is employed to perform the image processing shown in FIG. 14. The image processing in FIG. 14 is to be performed by the CPU (not shown) mounted on the image forming apparatus of this embodiment.

According to the first embodiment, before an object is printed, the transparent toner printing method (for full-surface or partial-surface printing of a document) designated when an object was stored is examined. Therefore, whether transparent toner is to be printed across the entire surface of a document, or only within a specific portion can be selected.

Furthermore, in the object printing process, the security dot printing method (full-surface or partial-surface printing) designated when the object was stored may be examined in order to determine whether the security dot should be printed for the entire surface of a document, or only for a specific portion.

According to a second embodiment of the present invention, a plurality of objects are selected, from among those stored in a BOX 301, and are printed using transparent toner.

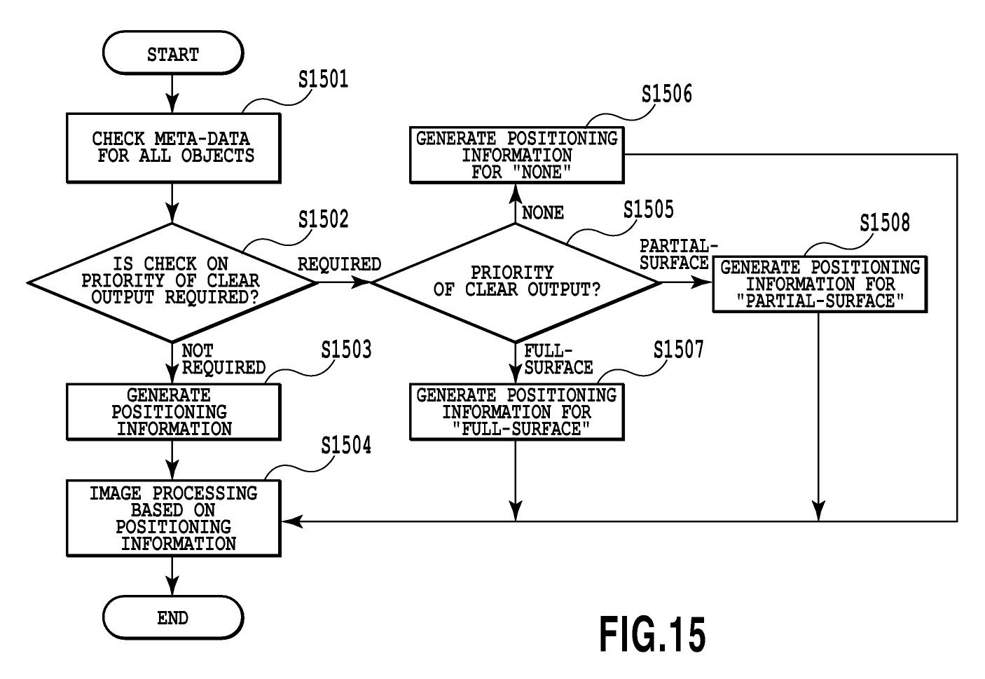

FIG. 15 is a flowchart showing the processing performed in the second embodiment. The processing in the flowchart in FIG. 15 is to be performed by a CPU (not shown) mounted on an image forming apparatus according to the present embodiment.

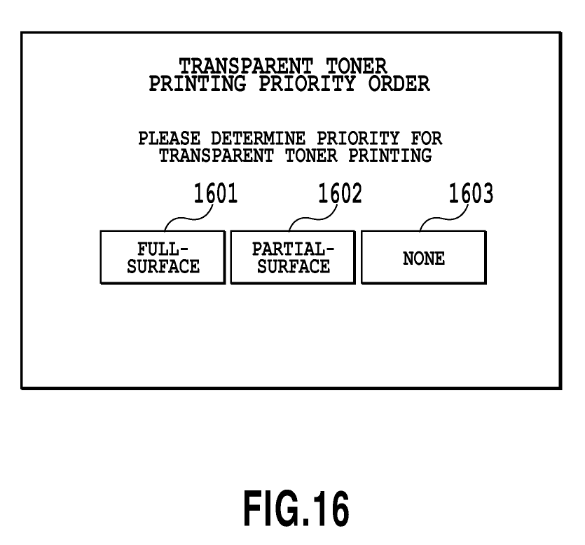

FIGS. 16 to 19 are diagrams showing example screens displayed on a user interface.

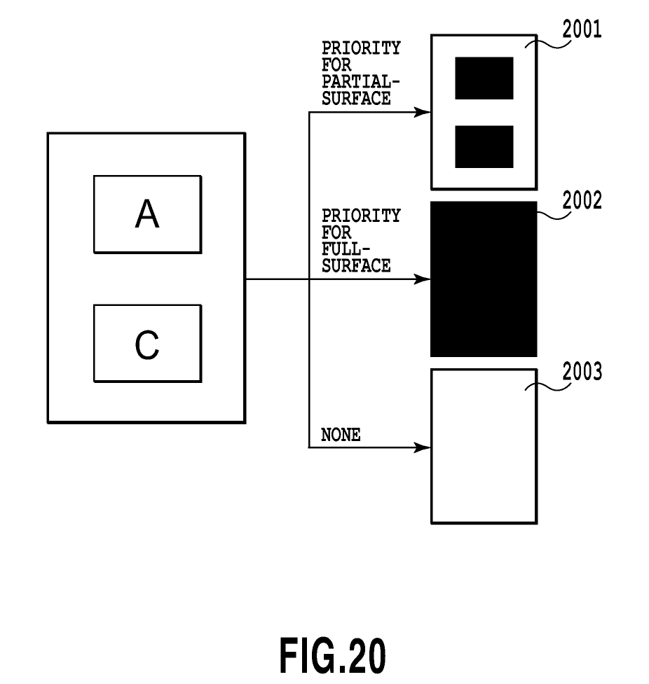

FIG. 20 is a diagram relating to a positioning information generation method.

A description will be given for a case wherein an area 801 in FIG. 8 is employed for editing and printing an object A803 and an object B804. At step S1501, meta-data for all the objects are examined. Then, at step S1502, these meta-data are employed to determine whether priority for transparent toner output, which has been designated in advance for an MFP, should be confirmed.

When priority for transparent toner output that has been pre-designated for the MFP need not be confirmed, at step S1503, as in the first embodiment, positioning information obtained based on the individual objects is employed. Then, at step S1504, the image processing is performed for outputting transparent toner, and thereafter, printing is initiated.

When priority for transparent toner output that has been pre-designated for the MFP must be confirmed, a check is performed to determine whether “full-surface” has been designated in meta-data 1001 for a selected object.

For example, when the object A803 and the object C805 are to be edited and printed, confirmation of the priority for transparent toner output is used. This is because “partial-surface” has been designated in the meta-data 1001 for the object A803 and “full-surface” has been designated in the meta-data 1001 for the object C805, and the object to which preferential should apply has not been identified.

On the other hand, when “partial-surface” has been designated in the meta-data 1001 for both the object A803 and the object B804, it can be uniformly determined that transparent toner is to be output only for the “partial-surface” status.

Further, when “partial-surface” is designated in the meta-data 1001 for the object A803 and “none” is designated in the meta-data 1001 for a newly added object, the object printing method can also be determined uniformly.

When it is determined at step S1502 that the priority for transparent toner output must be examined, at step S1505, to which item preferential applies is determined, and that item is designated in advance for the MFP 101 using a screen shown in FIG. 16.

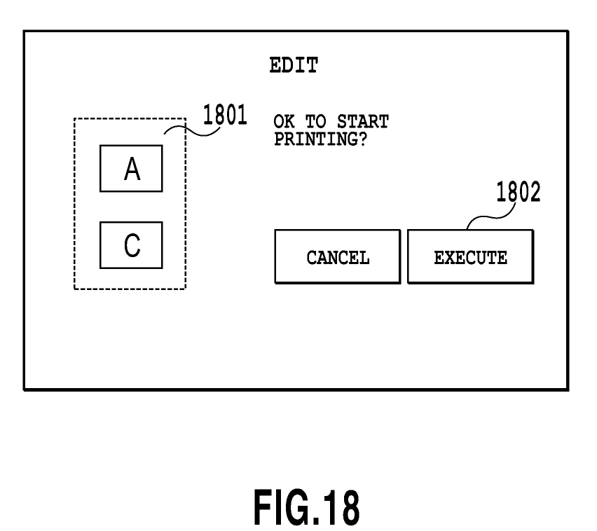

On the screen in FIG. 16, when a button 1601 is selected, “full-surface” is designated. And when a button 802 is depressed after “full-surface” has been selected, a preview 1801 is displayed on a screen shown in FIG. 18. In the preview 1801, the external frame of a document is displayed using dotted lines, and the external frame of an object is displayed using solid lines. Then, when an “execute” button 1802 is selected, the printing of the image displayed in the preview 1801 is started.

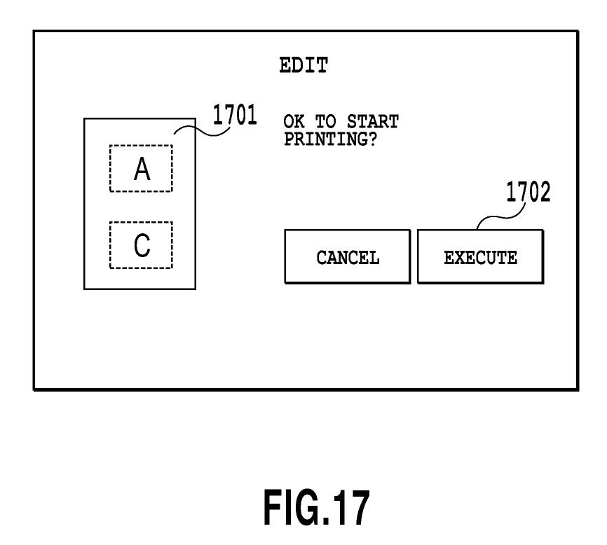

Likewise, when a button 1602 is selected on the screen in FIG. 16, “partial-surface” is designated, and a preview 1701 is displayed on a screen shown in FIG. 17. In the preview 1701 in FIG. 17, the external frame of a document is displayed using solid lines, and the external frame of an object is displayed using dotted lines. Then, when an “execute” button 1702 is selected, the printing of the image displayed in the preview 1701 is started.

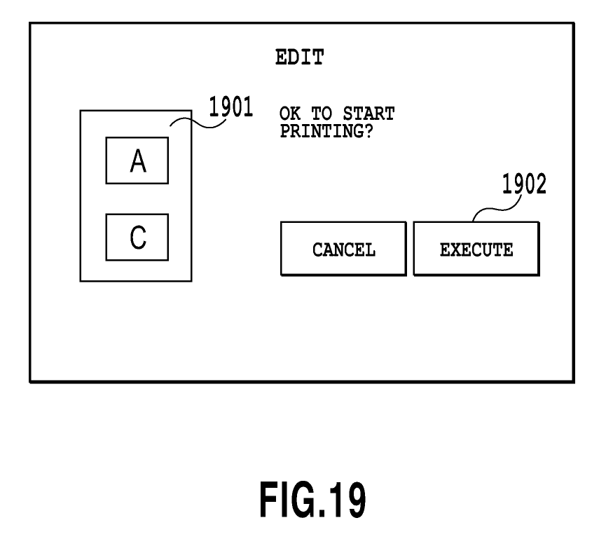

When a button 1603 is selected on the screen in FIG. 16, it is determined at step S1505 that priority for transparent toner output has not been selected and “none” is designated, and at step S1506, a preview 1901 for printing is displayed on a screen in FIG. 19. In the preview 1901 in FIG. 19, the external frames of a document and objects are displayed using solid lines. Then, when an “execute” button 1902 is selected, the printing of an image displayed in the preview 1901 is started.

When “full-surface” is selected at step S1505, positioning information is generated, at step S1507, for the entire surface of the document. When “partial-surface” is selected, positioning information is generated, at step S1508, for part of the document. And when “none” is selected, positioning information is not generated, at step S1506, for the document. As illustrated in FIG. 20, when the priority for transparent toner output is “full-surface”, positioning information 2002 is generated. When the priority for transparent toner output is “partial-surface”, positioning information 2001 is generated. And when the priority for transparent toner output is “none”, positioning information 2003 is generated. Finally, at step S1504, the image processing is performed, and an image displayed in the preview 1901 is printed.

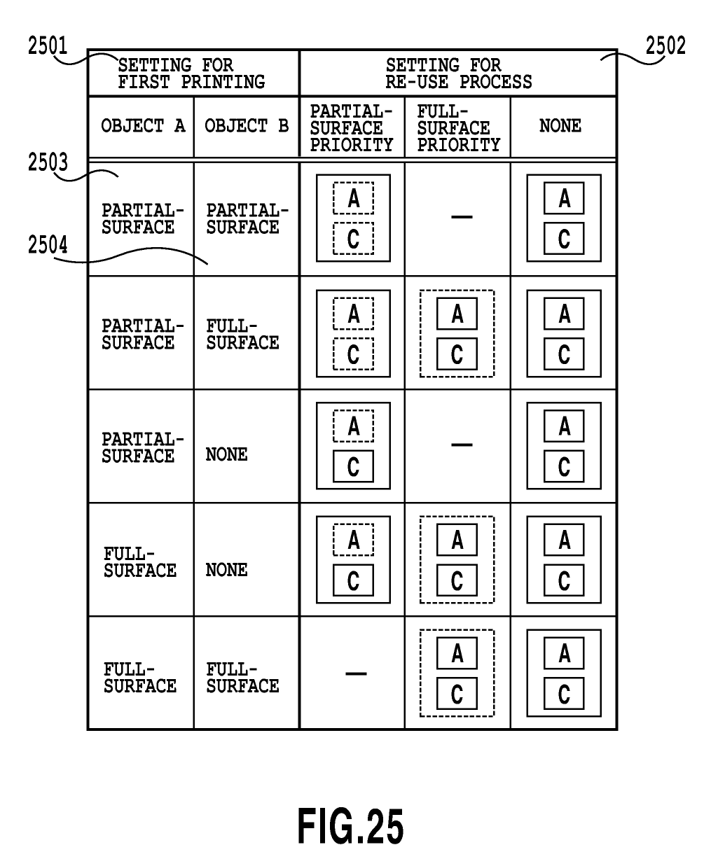

While referring to FIG. 25, the entry in a row 2501 indicates a transparent toner printing method (full-surface printing, partial-surface printing or none) employed prior to object division. 2503 indicates the transparent toner printing method before object division of object A. 2504 indicates the transparent toner printing method before object division of object B. The entry in a row 2502 indicates a priority item used when an object obtained by object division is to be employed again. The portions indicated by dotted lines represent printing using transparent toner, and the portions indicated by solid lines represent normal printing, i.e., printing without using transparent toner. The entry “-” represents the setting is invalid. For example, assume that “partial printing” is designated for both objects A and C, and “full-surface priority” is selected when the objects and C are to be employed again. In this case, printing of transparent toner on the entire surface will not provide satisfactory effects for the objects A and C.

According to a third embodiment, an object selected by a user is edited with a new character attribute, and the resultant object is printed using transparent toner.

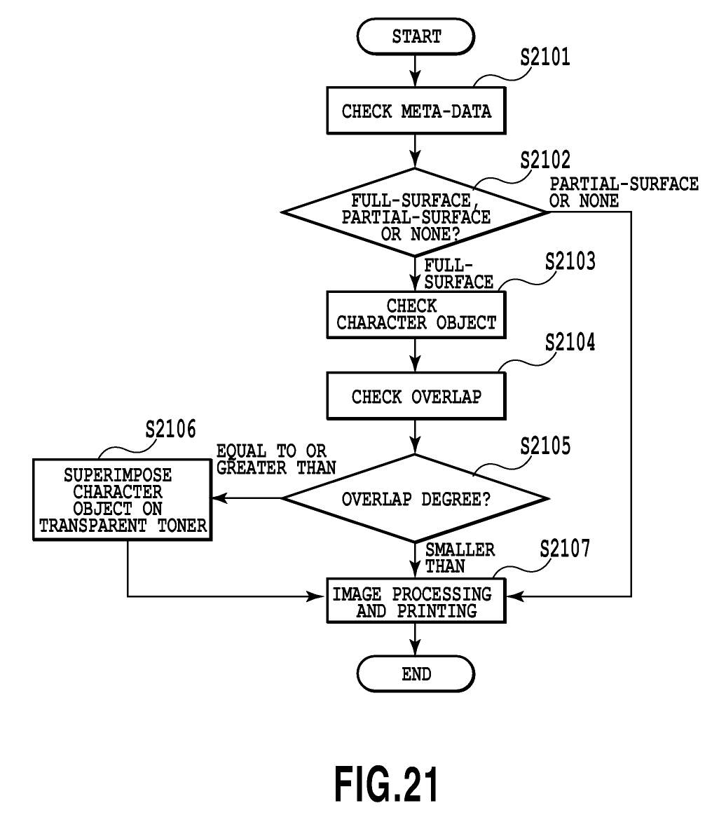

FIG. 21 is a flowchart showing the processing performed in the third embodiment. The processing in the flowchart in FIG. 21 is to be performed by a CPU (not shown) mounted on an image forming apparatus according to the present embodiment.

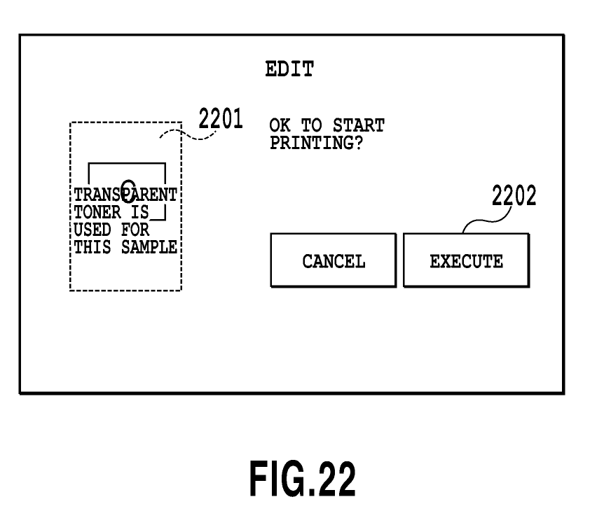

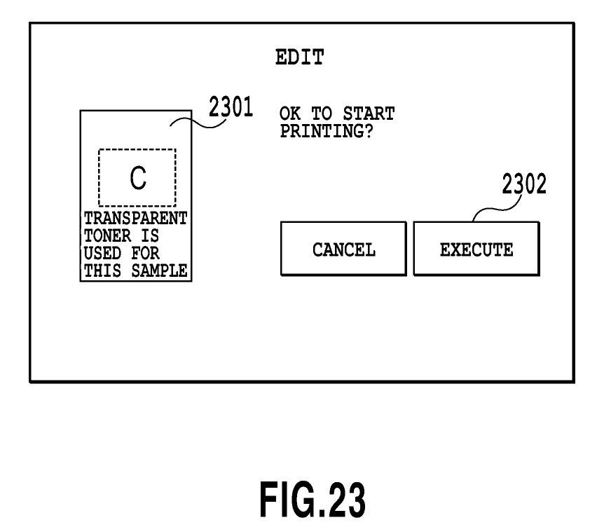

FIGS. 22 and 23 are diagrams illustrating example screens displayed on a user interface.

A description will now be given for a case wherein an object C805 is selected in an area 801 in FIG. 8, a new sentence is added to the object C805, and thereafter, a button 802 is depressed.

In this case, at step S2101 in FIG. 21, meta-data 1001 for the object C805 is confirmed, and at step S2102, a check is performed to determine whether “full-surface”, “partial-surface” or “none” is included in the meta-data 1001 for the object C805.

When “partial-surface” or “none” is included in the meta-data 1001 for the object C805, as well as in the first and second embodiments, positioning information is generated in accordance with the contents of the meta-data 1001. At step S2107, the image processing is performed and the object is printed.

When “full-surface” is included in the meta-data 1001 for the object C805, at step S2103, a check is performed to determine whether a character object is present in a document that has been edited, and at step S2104, a check is performed to determine whether the character object overlaps the object C805. Then, at step S2105, a screen in FIG. 22 or 23 is displayed.

Referring to a preview 2201 shown on the screen in FIG. 22, the size of the object C805 area overlapped by the character object is equal to or greater than a predetermined value. And in this case, when an “execute” button 2202 is depressed on the screen in FIG. 22, this is determined at step S2105. Then, at step S2106, it is determined that superimposition of the object C805 and the character object is to be effected using transparent toner. Thereafter, as in the first and second embodiment, positioning information is prepared, and at step S2107, the image processing is performed for printing the image as displayed in the preview.

As for a preview 2301 shown on the screen in FIG. 23, the size of the object C805 area overlapped by the character object need not be compared with the predetermined value (there is no overlap). In this case, application of the transparent toner to the character object is not possible. And thus, when an “execute” button 2302 is depressed, it is determined at step S2105 that the size of the object C805 area overlapped by the character object is smaller than the predetermined value. Thereafter, as in the first and second embodiments, positioning information is generated, and at step S2107 the image processing is performed for printing the image displayed in the preview.

[Overlap with a Character Object]

At step S2105, from among the number of pixels constituting a character object, a number of pixels that overlap an object for which transparent toner is to be printed is calculated, and a check is performed to determine whether the ratio of the pixels is equal to or greater than a value designated in advance for an MFP 101.

The present invention can be adapted for a system, an apparatus, a method, a computer program and a computer-readable recording medium. Furthermore, the present invention can be applied for a system that includes a plurality of apparatuses, or for a single apparatus.

For example, the present invention includes an embodiment wherein a computer program that provides the above described functions of the present invention is supplied to a system or an apparatus, using a computer-readable recording medium, or via a network, and a computer equipped with the system or the apparatus executes the computer program. Therefore, the embodiment also includes a computer program that provides the functions of the present invention. The computer program includes object code, a program executed by an interpreter, or script data supplied to an OS. The recording medium is, for example, a floppy (registered trademark) disk, a hard disk, an optical disk, a magneto-optical disk, a CD-ROM, a CD-R, a CD-RW, a magnetic tape, a non-volatile memory card, a ROM or a DVD. An example program supply method is one whereby the browser of a client computer is employed to download, via the Internet, a program to a recording medium, such as a hard disk. According to this method, a computer program file, or a compressed file that includes an automatic installation function, is downloaded via the Internet. Furthermore, the present invention also includes an embodiment wherein program code for a computer program is divided into a plurality of files, and the plurality of files are downloaded from different servers. The embodiment of the invention also includes a server that permits a plurality of users to download computer program files.

The functions of the above described embodiments may be provided when the computer performs the computer program. Further, these functions may also be performed when, based on an instruction from the computer program, an OS operated by the computer performs part, or all, of the actual processing.

The functions of the above embodiments may also be provided when the computer program read from a recording medium is written to a memory that is mounted on a function extension board inserted into the computer, or that is mounted in a function extension unit connected to a computer. That is, the functions of the embodiment may be provided when, based on an instruction from the computer program, a CPU mounted on a function extension board or in a function extension unit performs part, or all, of the actual processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-021422, filed Jan. 31, 2008, which is hereby incorporated by reference herein in its entirety.

What is claimed is:

1. An image forming apparatus comprising:
an addition unit for adding, to each of objects that constitute an original document, information indicating either that transparent toner is to be printed for the entire surface of the original document or that transparent toner is to be printed for only part of the original document;
a storage unit for storing the object; and
a generating unit for employing the object, stored in the storage unit, to generate image data that includes the object,
wherein, based on the information added to the object that is stored in the storage unit, the generating unit controls a number of pixels used for printing the transparent toner.

2. The image forming apparatus according to claim 1, wherein, when the addition unit adds information indicating use of transparent toner across the entire surface of a document, the object is printed using transparent toner for the entire surface.

3. The image forming apparatus according to claim 1, further comprising:
a determination unit for, when the generating unit employs an object other than a character object with the character object, determining the degree of overlap for the character object and the object other than the character object,
wherein the result obtained by the determination unit is employed to determine whether the transparent toner is to be employed for the entire surface or for only part of the original document.

4. An image forming method comprising:
adding, to each of objects that constitute an original document, information indicating either that transparent toner is to be printed for the entire surface of the original document or that transparent toner is to be printed for only part of the original document;
storing the object; and
employing the object to generate image data that includes the object,
wherein, in the employing, a number of pixels used for printing the transparent toner is controlled based on the information added to the object.

5. The image forming method according to claim 4, wherein, when information indicating use of transparent toner across the entire surface of a document is added in the adding, the object is printed using transparent toner for the entire surface.

6. The image forming method according to claim 4, further comprising:
determining, when an object other than a character object is employed with the character object, the degree of overlap for the character object and the object other than the character object,
wherein the result obtained by the determining is employed to determine whether the transparent toner is to be employed for the entire surface or for only part of the original document.

7. A computer-readable recording medium having a computer program to cause a computer to execute the image forming method according to claim 4.

8. An image processing apparatus which can store an image data in a storage unit and reprint the image data, the apparatus comprising:
an image data generation unit for generating an image data using transparent toner during a process for reprinting an object based on an information regarding transparent toner added to an object included in an image data which is stored by the storage unit;
an output unit for outputting the image data generated by the image data generation unit;
positioning information changing unit for changing information regarding position of printing; and
a printing unit for printing transparent toner based on the information regarding the position changed by the positioning information changing unit.

9. The image processing apparatus according to claim 8, further comprising:
an input unit for inputting priority information for transparent toner output,
wherein the image data generation unit generates the image data using transparent toner based on priority information input by the input unit.

10. An image processing method for controlling an image processing apparatus which can store an image data in a storage unit and reprint the image data, the method comprising:
an image data generation step for generating an image data using transparent toner during a process for reprinting an object based on an information regarding transparent toner added to an object included in an image data which is stored by the storage unit; and
an output step for outputting the image data generated by the image data generation step.

11. The image processing method according to claim 10, further comprising:
an input step for inputting priority information for transparent toner output,
wherein the image data generation step generates the image data using transparent toner based on priority information input by the input step.
